(19) United States
(12) Patent Application Publication
(10) Pub. No.: US 2006/0168263 A1
(43) Pub. Date: Jul. 27, 2006

(54) Monitoring telecommunication network elements

(76) Inventor: Andrew Blackmore, Dublin (IE)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 10/529,410

(22) PCT Filed: Sep. 29, 2003
(86) PCT No.: PCT/IB03/05605

§ 371 Date: Nov. 4, 2005

(30) Foreign Application Priority Data
Sep. 30, 2002 (GB) 0222549.8

(51) Int. Cl. G06F 15/16

(52) U.S. Cl. 709/230

(57) ABSTRACT

A method of monitoring the status of one or more network elements (NEs) linked together in a telecommunication network, comprising receiving a down status notification from a NE in the network, identifying one or more other NEs which are linked to the NE, and polling the or each other NE to determine the status thereof. The status of a NE may be operational, i.e., up, or non-operational, i.e., down. The down status notification may be received from a NE if the NE determines that the status of any other NE linked thereto is down. The down status notification may contain information on the NE which has output the notification. Identifying the or each other NE may comprise accessing the down status notification to obtain information on the NE which has output the notification, and using the information to obtain the identification of the or each other NE. Polling the or each other NE may comprise sending at least one SNMP get request to the NE. The method may be carried out using a network management system (NMS) of the network.

This invention relates to monitoring the status of telecommunication network elements.

Telecommunication networks commonly comprise network elements (NEs) and a network management system (NMS). One function of the NMS is to monitor the status of the NEs, i.e. to determine whether the status of each NE is operational i.e. ‘up’, or non-operational i.e. ‘down’. The NMS may also inform a customer of the network of the status of one or more of the NEs. This is particularly important if the status of a NE is down. In current networks, the NMS monitors the status of the NEs by polling each NE in turn to determine its status. If the NE replies its status is up, if it does not reply its status is down. As the NEs are polled in turn, such a monitoring method can be slower than that required by a customer of the network, especially if the customer is to take action concerning a down status of a NE. For example, in a 5000 element network, 4999 NEs will first be polled before determining the status of the 5000th element. If the status of the 5000th element is down, the time taken to determine this and inform the customer may be too long. In addition, the speed of this monitoring method will depend on the number of NEs in the network. For example, if it takes 10 sec to query a NE, it will take 100 sec to determine the status of all the NEs in a 10 element network, but will take 100,000 sec to determine the status of all the NEs in a 10,000 element network. The status of a NE, especially a down status, needs to be reported in a given, bounded time, for the information to be useful to a customer of the network, and the bounded time should not increase if the network size increases. It is therefore desirable to use a method of monitoring the status of NEs which can quickly determine the status of any NE, and which does not slow down as the size of the network increases.

According to a first aspect of the invention there is provided a method of monitoring the status of one or more network elements (NEs) linked together in a telecommunication network, comprising receiving a down status notification from a NE in the network, identifying one or more other NEs which are linked to the NE, polling the or each other NE to determine the status thereof.

On receipt of a down status notification, identifying and polling of the or each other NE can be carried out quickly. A customer of the network can therefore be informed of the status of a NE in a satisfactorily short period of time. Additionally, if it takes, for example, 0.2 sec for a notification to be received, and, for example, 10 sec to identify and poll another NE, it will take 10.2 sec to determine the status of the other NE. It will take the same amount of time if there are 10 NEs or 10,000 NEs in the network. There will therefore be a bounded time for notifying a customer of the status of a NE, and the invention removes the relationship between time taken to report a NE status and network size.

The status of a NE may be operational i.e. up. The status of a NE may be non-operational i.e. down.

A down status notification may be received from a NE if the NE determines that the status of any other NE linked thereto is down. Each NE may poll the or each other NE linked thereto to determine the status of the other NE. Each NE may poll the or each other NE linked thereto by signalling to the other NE, using a signalling protocol such as the public network to network interface (PNNI) protocol. If the or each other NE replies, its status may be considered to be up. If the or each other NE does not reply, its status may be considered to be down. The down status notification may contain information on the NE which has output the notification.

A down status notification may be received from a NE if the NE determines that the status of an interface thereof linked to one or more other NEs is down. The status of an interface may be down if the status of the or any of the other NEs linked to the interface is down. The down status notification may contain information on the NE which has output the notification, and information on the or each interface of the NE which is down. The or each interface may comprise a hardware port. The down status notification may comprise a hardware port down trap.

The down status notification may be received using a signalling protocol, for example the simple network management protocol (SNMP). The SNMP used preferably has down status notification resend functionality, such that notifications which do not arrive at their intended destination may be resent a configurable number of times. SNMP version 3 has such resend functionality.

Identifying the or each other NE may comprise accessing the down status notification to obtain information on the NE which has output the notification. Identifying the or each other NE may comprise accessing the down status notification to obtain information on the NE which has output the notification and information on the or each interface of the NE which is down. Identifying the or each other NE may comprise accessing a links database containing details of each NE and the or each other NE linked thereto, and using the information to obtain the identification of the or each other NE. Identifying the or each other NE may comprise accessing the links database and using the information to obtain the IP address of the or each other NE.

Polling the or each other NE may comprise sending at least one SNMP get request to the NE. Polling the or each other NE may comprise using the SNMP over transmission control protocol/internet protocol (TCP/IP). Polling the or each other NE may comprise using internet control message protocol (ICMP) over IP.

The method may comprise using a network management system (NMS) of the telecommunication network. The NMS may perform a number of functions, including monitoring the status of one or more NEs of the network. The NMS may be run on a computer system, which may comprise, for example, a Solaris computer system, or a HPUX computer system, or a Windows NT/2000 computer system. The NMS computer system may be linked to the or each or some of the NEs of the network. The NMS computer system may be able to communicate with the or each or some of the NEs of the network over IP.

The NMS may comprise a fault manager module. The fault manager module may receive the down status notification from the NE. The fault manager module may receive the down status notification using a signalling protocol, for example SNMP. The fault manager module may place the down status notification in a notification database of the NMS. The fault manager module may output a message on receipt of a down status notification.

The NMS may comprise a monitoring module. The monitoring module may receive a message output from the fault manager module when it receives a down status notification. The monitoring module may access the down status notification, to obtain information on the NE which has output the notification. The monitoring module may access the down status notification, to obtain information on the NE which has output the notification, and information on the or each interface of the NE which is down. The monitoring module may access a links database of the NMS containing details of each NE and the or each other NE linked thereto, and use the information to obtain the identification of the or each other NE. The monitoring module may access a links table of the links database and use the information to obtain the identification of the or each other NE. The monitoring module may access the links database and use the information to obtain the IP address of the or each other NE. The monitoring module may poll the or each other NE to determine the status thereof. The monitoring module may poll the or each other NE by sending at least one SNMP get request to the NE. The monitoring module may poll the or each other NE using the SNMP over TCP/IP. The monitoring module may determine the status of the or each or some of the NEs of the network, and may add the status information to a status database of the NMS.

The NMS may comprise a graphical user interface (GUI) module. The GUI module may receive information on the status of one or more of the NEs of the network from the status database. The GUI module may receive information on changes in the status of one or more of the NEs of the network from the status database. The GUI module may be used to report the status of one or more NEs of the network to a customer of the network. The GUI module may be used to report changes in the status of one or more NEs of the network to a customer of the network. The GUI module may use a NEs listing screen to report the status and/or changes in the status of one or more NEs in the network to a customer of the network. The GUI module may report an up status of a NE using a green ball in the NEs listing screen next to the NE. The GUI module may report a down status of a NE using a red ball in the NEs listing screen next to the NE.

The network elements in the telecommunication network may comprise, for example, nodes, switches or routers. The telecommunication network may comprise, for example, an asynchronous transfer mode (ATM) network or an internet protocol (IP) network, or a multiprotocol label switching (MPLS) network.

The method may run in parallel with polling each NE in the telecommunication network in turn.

According to a second aspect of the invention there is provided a computer program product for monitoring the status of one or more network elements (NEs) linked together in a telecommunication network, comprising computer readable program means for receiving a down status notification from a NE of the network, computer readable program means for identifying one or more other NEs which are linked to the NE, computer readable program means for polling the or each other NE to determine the status thereof.

The computer program product may be comprised in a network management system (NMS) of the telecommunication network. The NMS may run on a computer system, which may comprise, for example, a Solaris computer system, a HPUX computer system, or a Windows NT/2000 computer system.

The computer readable program means for receiving a down status notification from a NE of the network may comprise a fault manager module of the NMS.

The fault manager module may receive the down status notification using a signalling protocol, for example SNMP. The fault manager module may place the down status notification in a notification database of the NMS. The fault manager module may output a message on receipt of a down status notification.

The computer readable program means for identifying one or more other NEs which are linked to the NE may comprise a monitoring module of the NMS. The computer readable program means for polling the or each other NE to determine the status thereof may comprise the monitoring module of the NMS. The monitoring module may receive a message output from the fault manager module when it receives a down status notification. The monitoring module may access the down status notification, to obtain information on the NE which has output the notification. The monitoring module may access the down status notification, to obtain information on the NE which has output the notification, and information on the or each interface of the NE which is down. The monitoring module may access a links database of the NMS containing details of each NE and the or each other NE linked thereto, and use the information to obtain the identification of the or each other NE. The monitoring module may access a links table of the links database and use the information to obtain the identification of the or each other NE. The monitoring module may access the links database and use the information to obtain the IP address of the or each other NE. The monitoring module may poll the or each other NE to determine the status thereof. The monitoring module may poll the or each other NE by sending at least one SNMP get request to the NE. The monitoring module may poll the or each other NE using the SNMP over TCP/IP. The monitoring module may determine the status of the or each or some of the NEs of the network, and may add the status information to a status database of the NMS.

The computer program product may further comprise a graphical user interface (GUI) module of the NMS. The GUI module may receive information on the status of one or more of the NEs of the network from the status database. The GUI module may receive information on changes in the status of one or more of the NEs of the network from the status database. The GUI module may be used to report the status of one or more NEs of the network to a customer of the network. The GUI module may be used to report changes in the status of one or more NEs of the network to a customer of the network. The GUI module may use a NEs listing screen to report the status and/or changes in the status of one or more NEs in the network to a customer of the network. The GUI module may report an up status of a NE using a green ball in the NEs listing screen next to the NE. The GUI module may report a down status of a NE using a red ball in the NEs listing screen next to the NE.

According to a third aspect of the invention there is provided a computer system in which the status of one or more network elements (NEs) linked together in a telecommunication network are monitored, comprising receiving means for receiving a down status notification from a NE of the network, identification means for identifying one or more other NEs which are linked to the NE, polling means for polling the or each other NE to determine the status thereof.

According to a fourth aspect of the invention there is provided a computer system whose operation is directed by the computer program product according to the second aspect of the invention.

The computer system of the third or fourth aspect of the invention may comprise, for example, a Solaris computer system, a HPUX computer system, or a Windows NT/2000 computer system.

According to a fifth aspect of the invention there is provided a computer readable medium on which is stored a computer program of instructions for a computer system which monitors the status of one or more network elements (NEs) linked together in a telecommunication network, comprising means for receiving a down status notification from a NE of the network, means for identifying one or more other NEs which are linked to the NE, means for polling the or each other NE to determine the status thereof.

According to a sixth aspect of the invention there is provided a program storage device readable by a machine and encoding a program of instructions for executing the method according to the first aspect of the invention.

An embodiment of the invention will now be described, by way of example only, with reference to the accompanying drawings, in which:

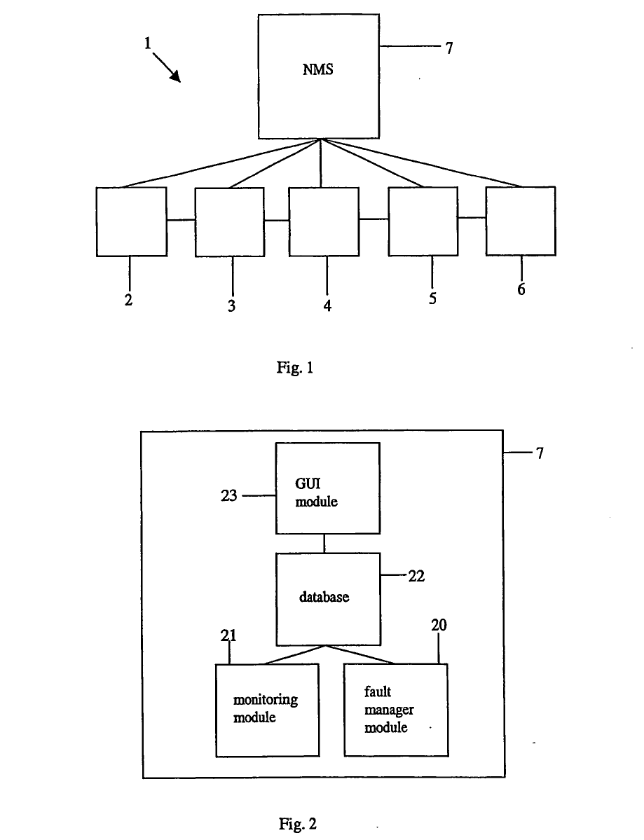

FIG. 1 is a schematic representation of a telecommunication network, comprising network elements whose status are monitored using the method of the first aspect of the invention, and

FIG. 2 is a schematic representation of a network management system of the telecommunication network of FIG. 1.

FIG. 1 illustrates a telecommunications network 1, comprising network elements (NEs) 2, 3, 4, 5 and 6, and a network management system (NMS) 7. The NEs each comprise a node, and are linked together as shown, using cables. Each NE is additionally linked to the NMS as shown using cables.

The NMS 7 is further illustrated in FIG. 2. This is run on a Windows NT computer system. The NMS 7 comprises a fault manager module 20, a monitoring module 21, a database, 22 and a graphical user interface (GUI) module 23, linked together as shown.

The status of one or more of the NEs in the network is monitored as follows.

Each NE 2 to 6 will regularly poll the or each other NE linked thereto to determine the status of the other NE. This is carried out using the PNNI signalling protocol. If the or each other NE replies, its status is considered to be up, if the or each other NE does not reply, its status is considered to be down. If an NE determines that the status of any other NE linked thereto is down, it issues a down status notification which is received by the fault manager module 20 of the NMS 7, using SNMP. The fault manager module 20 places the down status notification in the database 22 of the NMS 7, and outputs a message to the monitoring module 21 of the NMS 7.

The monitoring module 21 receives a message output from the fault manager module 20 when it receives a down status notification. The monitoring module 21 accesses the down status notification, to obtain information on the NE which has output the notification. The monitoring module 20 then accesses the database 22 of the NMS 7, which contains details of each NE and the or each other NE linked thereto, and uses the information from the notification to obtain the identification of the or each other NE, e.g. the IP address of the or each other NE.

The monitoring module 20 polls the or each other NE to determine the status thereof, by sending at least one SNMP get request to the NE, using the SNMP over TCP/IP. Once the status of the or each other NE has been determined, this is added to the database 22 of the NMS 7.

The GUI module 23 of the NMS 7 receives information on the status of the NEs of the network from the database 22, and reports changes in the status of the NEs to a customer of the network. This is carried out using a NEs listing screen, wherein an up status of a NE is reported using a green ball in the screen next to the NE, and a down status of a NE is reported using a red ball in the screen next to the NE.

Thus if a NE goes down, this will be detected by a neighbouring NE, and a down status notification issued to the NMS. The NMS can then poll the down NE to determine/verify its status. This will be carried out on receipt of a down status notification, i.e. the time delay associated with polling in a queue is eliminated. A customer of the network can therefore be informed of the down status of a NE in a satisfactorily short period of time. Additionally, it will take the same amount of time to determine the status of a NE if there are 10 NEs or 10,000 NEs in the network. There will therefore be a bounded time for notifying a customer of the status of a NE.

1-43. (canceled)

44. A method of monitoring a status of network elements (NEs) linked together in a telecommunication network, comprising the steps of:
a) receiving a down status notification from a NE in the network;
b) identifying at least one other NE which is linked to the NE; and
c) polling one of the NE and the at least one other NE to determine the status thereof.

45. The method according to claim 44, in which the status of the NE is operational.

46. The method according to claim 44, in which the status of the NE is non-operational.

47. The method according to claim 44, in which the down status notification is received from the NE if the NE determines that the status of the at least one other NE linked thereto is non-operational.

48. The method according to claim 47, in which each NE polls the one of the NE and the at least one other NE linked thereto to determine the status of the at least one other NE.

49. The method according to claim 48, in which each NE polls the one of the NE and the at least one other NE linked thereto by signaling to the at least one other NE, using a signaling protocol.

50. The method according to claim 48, in which, if the one of the NE and the at least one other NE replies, its status is considered to be operational.

51. The method according to claim 48, in which, if the one of the NE and the at least one other NE does not reply, its status is considered to be non-operational.

52. The method according to claim 44, in which the down status notification contains information on the NE which has output the notification.

53. The method according to claim 44, in which the down status notification is received from a NE if the NE determines that the status of an interface thereof linked to at least one other NE is non-operational.

54. The method according to claim 53, in which the status of the interface is non-operational if the status of the one of the NE and the at least one other NE linked to the interface is non-operational.

55. The method according to claim 53, in which the down status notification contains information on the NE which has output the notification, and information on the interface of the NE which is non-operational.

56. The method according to claim 53, in which the interface comprises a hardware port, and the down status notification comprises a hardware port down trap.

57. The method according to claim 44, in which the down status notification is received using a signaling protocol.

58. The method according to claim 57, in which the signaling protocol comprises a simple network management protocol (SNMP).

59. The method according to claim 44, in which the identifying step comprises accessing the down status notification to obtain information on the NE which has output the notification.

60. The method according to claim 59, in which the identifying step comprises accessing a links database containing details of each NE and the at least one other NE linked thereto, and using the information to obtain the identification of the one of the NE and the at least one other NE.

61. The method according to claim 60, in which the identifying step comprises accessing the links database and using the information to obtain an internet protocol (IP) address of the one of the NE at the at least one other NE.

62. The method according to claim 44, in which the polling step comprises sending at least one simple network management protocol (SNMP) get request to the NE.

63. The method according to claim 62, in which the polling step comprises using the SNMP over transmission control protocol/internet protocol (TCP/IP).

64. The method according to claim 44, and using a network management system (NMS) of the telecommunication network.

65. The method according to claim 64, in which the NMS comprises a fault manager module.

66. The method according to claim 65, in which the fault manager module receives the down status notification from the NE.

67. The method according to claim 66, in which the fault manager module places the down status notification in a notification database of the NMS.

68. The method according to claim 66, in which the fault manager module outputs a message on receipt of the down status notification.

69. The method according to claim 68, in which the NMS comprises a monitoring module.

70. The method according to claim 69, in which the monitoring module receives a message output from the fault manager module when it receives the down status notification.

71. The method according to claim 70, in which the monitoring module accesses the down status notification, to obtain information on the NE which has output the notification.

72. The method according to claim 71, in which the monitoring module accesses a links database of the NMS containing details of each NE and the at least one other NE linked thereto, and uses the information to obtain the identification of one of the NE and each other NE.

73. The method according to claim 72, in which the monitoring module polls one of the NE and each other NE to determine the status thereof.

74. The method according to claim 73, in which the monitoring module determines the status of at least one NE of the network, and adds status information to a status database of the NMS.

75. The method according to claim 64, in which the NMS comprises a graphical user interface (GUI) module.

76. The method according to claim 75, in which the GUI module is used to report the status of one of the NE and the at least one other NE of the network to a customer of the network.

77. The method according to claim 44, in which the NEs in the telecommunication network comprise nodes, switches and routers.

78. A computer program product for monitoring a status of network elements (NEs) linked together in a telecommunication network, comprising:
a) computer readable program means for receiving a down status notification from a NE of the network;
b) computer readable program means for identifying at least one other NE which is linked to the NE; and
c) computer readable program means for polling one of the NE and the at least one other NE to determine the status thereof.

79. The computer program product according to claim 78, comprised in a network management system (NMS) of the telecommunication network.

80. The computer program product according to claim 79, in which the computer readable program means for receiving the down status notification from the NE of the network comprises a fault manager module of the NMS.

81. The computer program product according to claim 79, in which the computer readable program means for identifying the at least one other NE which is linked to the NE comprises a monitoring module of the NMS.

82. The computer program product according to claim 81, in which the computer readable program means for polling comprises the monitoring module of the NMS.

83. A computer system in which a status of network elements (NEs) linked together in a telecommunication network is monitored, comprising:
a) receiving means for receiving a down status notification from a NE of the network;
b) identification means for identifying at least one other NE which is linked to the NE; and
c) polling means for polling one of the NE and the at least one other NE to determine the status thereof.

84. A computer system whose operation is directed by the computer program product according to claim 78.

85. A computer readable medium on which is stored a computer program of instructions for a computer system which monitors a status of network elements (NEs) linked together in a telecommunication network, comprising:
a) means for receiving a down status notification from a NE of the network;
b) means for identifying at least one other NE which is linked to the NE; and
c) means for polling one of the NE and the at least one other NE to determine the status thereof.

86. A program storage device readable by a machine and encoding a program of instructions for executing the method according to claim 44.
